(19) United States
(12) Patent Application Publication
(10) Pub. No.: US 2012/0084098 A1
(43) Pub. Date: Apr. 5, 2012

(54) SYSTEM AND METHOD FOR POPULATING ELECTRONIC HEALTHCARE FORMS

(76) Inventors: Andrew Braunstein, Weston, MA (US); Michael M. Stern, Needham, MA (US)

(21) Appl. No.: 12/894,617

(22) Filed: Sep. 30, 2010

(51) Int. Cl. G06Q 50/00; G06F 3/048

(52) U.S. Cl. 705/3; 715/224

(57) ABSTRACT

A computer-implemented method, computer program product, and computing system for monitoring an answer being solicited from a user of a healthcare system concerning a question included within an electronic healthcare form. The user is provided with information that assists the user in answering the question on the electronic healthcare form.

### TECHNICAL FIELD

This disclosure relates to electronic healthcare forms and, more particularly, to systems and methods for assisting clinicians when populating electronic healthcare forms.

### BACKGROUND

The Prospective Payment System (PPS) is a system of payments designed by the government to reimburse Home Health Agencies (HHA's) for caring for Medicare Patients. PPS has also been leveraged by some private insurers.

PPS is typically based upon setting a fixed payment for each 60 day period of care. These fixed payments are determined by the HHA collecting clinical information according to a government specified data set, known as the Outcome and ASsessment Information Set (OASIS).

Under PPS, HHA's are reimbursed predefined amounts for Medicare admissions. The Federal government has defined an algorithm (known as the Home Health Resource Grouper; HHRG) that identifies how much resources are necessary to care for a patient based on the OASIS answers. The federal government then associates a reimbursement amount with each HHRG. Unfortunately, providing the information required by OASIS is often a time-consuming and redundant process.

### Summary of Disclosure

In a first implementation, a computer-implemented, form-population method includes monitoring an answer being solicited from a user of a healthcare system concerning a question included within an electronic healthcare form. The user is provided with information that assists the user in answering the question on the electronic healthcare form.

One or more of the following features may be included. The electronic healthcare form may be associated with a healthcare patient. A portion of a medical chart associated with the healthcare patient may be associated with a portion of the electronic healthcare form. Providing the user with information may include providing the user with one or more answers populating a previous version of the electronic healthcare form. Providing the user with information may include obtaining one or more pieces of corresponding information. Providing the user with information further may include calculating information based, at least in part, upon the one or more pieces of corresponding information, thus generating calculated information. Providing the user with information further may include providing the user with the calculated information.

In another implementation of this disclosure, a computer program product resides on a computer readable medium and has a plurality of instructions stored on it. When executed by a processor, the instructions cause the processor to perform operations including monitoring an answer being solicited from a user of a healthcare system concerning a question included within an electronic healthcare form. The user is provided with information that assists the user in answering the question on the electronic healthcare form.

One or more of the following features may be included. The electronic healthcare form may be associated with a healthcare patient. A portion of a medical chart associated with the healthcare patient may be associated with a portion of the electronic healthcare form. Providing the user with information may include providing the user with one or more answers populating a previous version of the electronic healthcare form. Providing the user with information may include obtaining one or more pieces of corresponding information. Providing the user with information further may include calculating information based, at least in part, upon the one or more pieces of corresponding information, thus generating calculated information. Providing the user with information further may include providing the user with the calculated information.

In another implementation, a computing system includes at least one processor and at least one memory architecture coupled with the at least one processor. A first software module is executed on the at least one processor and the at least one memory architecture. The first software module is configured to perform operations including monitoring an answer being solicited from a user of a healthcare system concerning a question included within an electronic healthcare form. A second software module is executed on the at least one processor and the at least one memory architecture. The second software module is configured to perform operations including providing the user with information that assists the user in answering the question on the electronic healthcare form.

One or more of the following features may be included. The electronic healthcare form may be associated with a healthcare patient. A portion of a medical chart associated with the healthcare patient may be associated with a portion of the electronic healthcare form. Providing the user with information may include providing the user with one or more answers populating a previous version of the electronic healthcare form. Providing the user with information may include obtaining one or more pieces of corresponding information. Providing the user with information further may include calculating information based, at least in part, upon the one or more pieces of corresponding information, thus generating calculated information. Providing the user with information further may include providing the user with the calculated information.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a form population process executed in whole or in part by a computer coupled to a distributed computing network;

FIG. 2 is a flowchart of the form population process of FIG. 1; and

FIGS. 3-6 are diagrammatic views of data entry screens rendered by the form population process of FIG. 1.

Like reference symbols in the various drawings indicate like elements.

### DETAILED DESCRIPTION OF THE PREFERRED EMBODIMENTS

As will be appreciated by one skilled in the art, the present disclosure may be embodied as a method, system, or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device.

Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present disclosure is described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

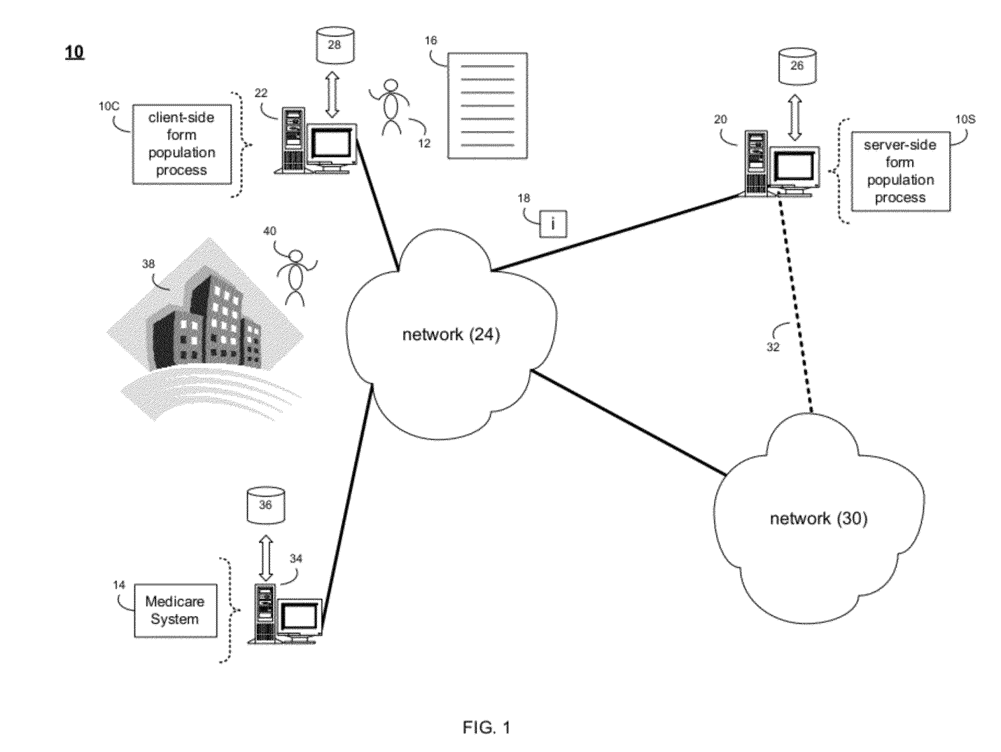

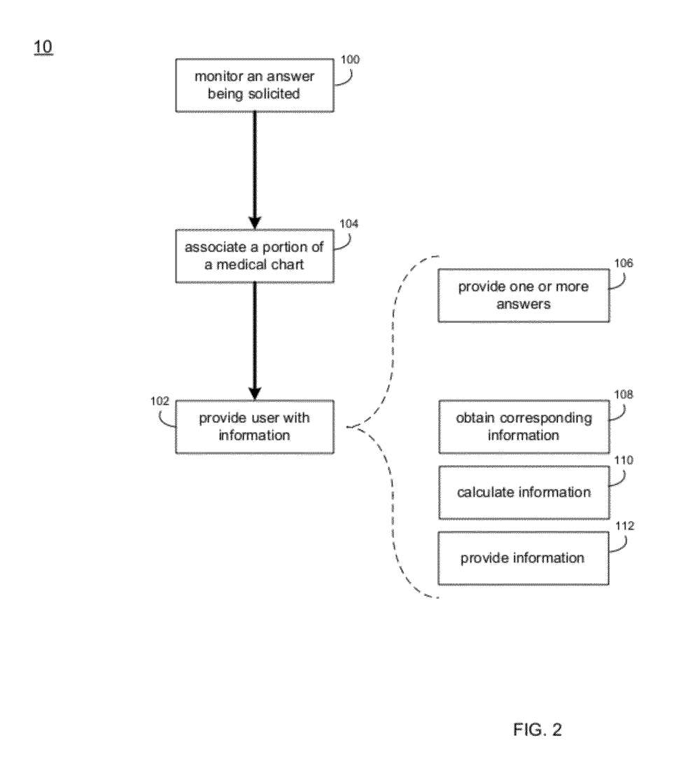

Referring to FIGS. 1 & 2, there is shown form population process 10 that may monitor 100 an answer being solicited from a user (e.g., user 12) of a healthcare system/process (e.g., Medicare System 14) concerning a question included within an electronic healthcare form (e.g., electronic healthcare form 16). The user (e.g., user 12) may be provided 102 with information (e.g., information 18) that may assist the user (e.g., user 12) in answering the question on the electronic healthcare form (e.g., electronic healthcare form 16).

Form population process 10 may be a server-side application (e.g., server-side form population process 10S executed on server computer 20); a client-side application (i.e., client-side form population process 10C executed on client computer 22); or a hybrid server-side/client-side application (e.g., server-side form population process 10S executed on server computer 20 in coordination/cooperation with client-side form population process 10C executed on client computer 22).

If configured as a server-side application (e.g., server-side form population process 10S) or a hybrid server-side/client-side application (e.g., server-side form population process 10S in coordination/cooperation with client-side form population process 10C), all or a portion of form population process 10 may reside on and may be executed by server computer 20, which may be connected to network 24 (e.g., the Internet or a local area network). Examples of server computer 20 may include, but are not limited to: a personal computer, a server computer, a series of server computers, a mini computer, and a mainframe computer. Server computer 20 may execute a network operating system, examples of which may include but are not limited to: Microsoft Windows XP Server™; Novell Netware™; and Redhat Linux™.

If configured as a server-side application (e.g., server-side form population process 10S) or a hybrid server-side/client-side application (e.g., server-side form population process 10S in coordination/cooperation with client-side form population process 10C), all or a portion of the instruction sets and subroutines of form population process 10, which may be stored on storage device 26 coupled to server computer 20, may be executed by one or more processors (not shown) and one or more memory architectures (not shown) incorporated into server computer 20. Storage device 26 may include but is not limited to: a hard disk drive; a tape drive; an optical drive; a RAID array; a random access memory (RAM); and a read-only memory (ROM).

If configured as a client-side application (e.g., client-side form population process 10C) or a hybrid server-side/client-side application (e.g., server-side form population process 10S in coordination/cooperation with client-side form population process 10C), all or a portion of form population process 10 may reside on and may be executed by client computer 22, which may be connected to network 24 (e.g., the Internet or a local area network). Examples of client computer 22 may include, but are not limited to: a personal computer, a laptop computer, a notebook computer, a tablet computer, a PDA, and a data-enabled cell phone. Client computer 20 may execute an operating system, examples of which may include but are not limited to: Microsoft Windows™; and Redhat Linux™.

If configured as a client-side application (e.g., client-side form population process 10C) or a hybrid server-side/client-side application (e.g., server-side form population process 10S in coordination/cooperation with client-side form population process 10C), all or a portion of the instruction sets and subroutines of form population process 10, which may be stored on storage device 28 coupled to client computer 22, may be executed by one or more processors (not shown) and one or more memory architectures (not shown) incorporated into client computer 22. Storage device 28 may include but is not limited to: a hard disk drive; a tape drive; an optical drive; a RAID array; a random access memory (RAM); and a read-only memory (ROM).

For illustrative purposes only, form population process 10 will be generically discussed without reference to the computer that is executing form population process 10, with the understanding that form population process 10 may be a server-side application; a client-side application; or a hybrid server-side/client-side application.

Server computer 20 may execute a web server application, examples of which may include but are not limited to: Microsoft IIS™, Novell Webserver™, or Apache Webserver™, that allows for HTTP (i.e., HyperText Transfer Protocol) access to server computer 20 via network 24. Network 24 may be connected to one or more secondary networks (e.g., network 30), examples of which may include but are not limited to: a local area network; a wide area network; or an intranet, for example. Server computer 20 may be coupled to network 30 via one or more links (e.g., link 32 shown in phantom).

As discussed above, form population process 10 may monitor 100 an answer being solicited from a user (e.g., user 12) of a healthcare system/process (e.g., Medicare System 14) concerning a question included within an electronic healthcare form (e.g., electronic healthcare form 16). The user (e.g., user 12) may be provided 102 with information (e.g., information 18) that may assist the user (e.g., user 12) in answering the question on the electronic healthcare form (e.g., electronic healthcare form 16). Various portions of the healthcare system/process (e.g., Medicare System 14) may reside on and may be executed by server computer 34, which may be connected to network 24 (or secondary network 30). Examples of server computer 34 may include, but are not limited to: a personal computer, a server computer, a series of server computers, a mini computer, and a mainframe computer. Server computer 34 may execute a network operating system, examples of which may include but are not limited to: Microsoft Windows XP Server™; Novell Netware™; and Redhat Linux™.

The instruction sets and subroutines of the healthcare system/process (e.g., Medicare System 14), which may be stored on storage device 36 coupled to server computer 34, may be executed by one or more processors (not shown) and one or more memory architectures (not shown) incorporated into server computer 34. Storage device 36 may include but is not limited to: a hard disk drive; a tape drive; an optical drive; a RAID array; a random access memory (RAM); and a read-only memory (ROM).

For illustrative purposes, assume that user 12 is a clinician at healthcare facility 38 (e.g., a primary care provider). Further assume that user 12 is treating healthcare patient 40 at healthcare facility 38. As discussed above, during the course of treating patient 40, user 12 may be required by e.g., Medicare System 14, a health insurance company (not shown) or some other supervising entity (not shown) to repeatedly populate electronic healthcare forms (e.g., electronic healthcare form 16 associated with healthcare patient 40), which may include questions that are identical to or based upon previously-answered questions from electronic healthcare forms that were populated earlier.

While healthcare facility 38 is described above (by way of example) as being a primary care provider, this is for illustrative purposes only and is not intended to be a limitation of this disclosure, as other configurations are possible and are considered to be within the scope of this disclosure. For example, healthcare facility 38 may be the patient's home or any other place where healthcare services are rendered.

For example, when form population process 10 is configured by e.g., user 12, form population process 10 may associate 104 a portion of a medical chart (associated with healthcare patient 40) with a portion of electronic healthcare form 16.

The manner in which these associations are made may vary depending upon the relationship between the electronic healthcare form currently being populated and the older previously-populated electronic healthcare form or the medical chart of healthcare patient 40. For example, suppose question six (e.g., date of birth?) on the electronic healthcare form currently being populated (e.g., electronic healthcare form 16) is identical to question seven (e.g., date of birth?) on the previously-populated electronic healthcare form. Accordingly, as these two questions are identical, the answers should be the same. Therefore, when providing 102 user 12 with information (e.g., information 18) that may assist user 12 in answering e.g., question six on electronic healthcare form 16, form population process 10 may simply provide 106 user 12 with one or more answers (e.g., the answer to question seven) that populates a previous version of electronic healthcare form 16.

For liability reasons, the clinician (e.g., user 12) may be required to enter the answer. Accordingly, form population process 12 may be configured to only inform user 12 of the previous answer and allow user 12 to populate electronic healthcare form 16 (as opposed to directly populating electronic healthcare form 16).

Sometimes the information provided 102 by form population process 10 may not be identical to the information obtained from the previously-populated electronic healthcare form or the medical chart of healthcare patient 40 and may need to be derived in some manner. For example, suppose question six (e.g., age?) on the electronic healthcare form currently being populated is related to question seven (e.g., date of birth?) on the previously-populated electronic healthcare form. Accordingly, as these two questions are related, the answer to question six (e.g., age?) on the electronic healthcare form currently being populated should be determinable from the answer previously provided to question seven (e.g., date of birth?). Therefore, form population process 10 may be configured to subtract the date of birth of healthcare patient 40 from the current date (which is obtainable from e.g., the operating system of server computer 20). Accordingly, when providing 102 user 12 with information (e.g., information 18) that may assist user 12 in answering e.g., question six on electronic healthcare form 16, form population process 10 may obtain 108 one or more pieces of corresponding information, such as: the date of birth of healthcare patient 40 that is obtainable from question seven of the previously-populated electronic healthcare form; and the current date that is obtainable from e.g., the operating system of server computer 20. Form population process 10 may then calculate 110 information (e.g., the age of healthcare patient 40) based, at least in part, upon the one or more pieces of corresponding information (e.g., date of birth of healthcare patient 40 and current date), thus generating calculated information. Form population process 10 may then provide 112 user 12 with the calculated information (e.g., information 18, namely the age of healthcare patient 40), which may assist user 12 in answering e.g., question six on electronic healthcare form 16

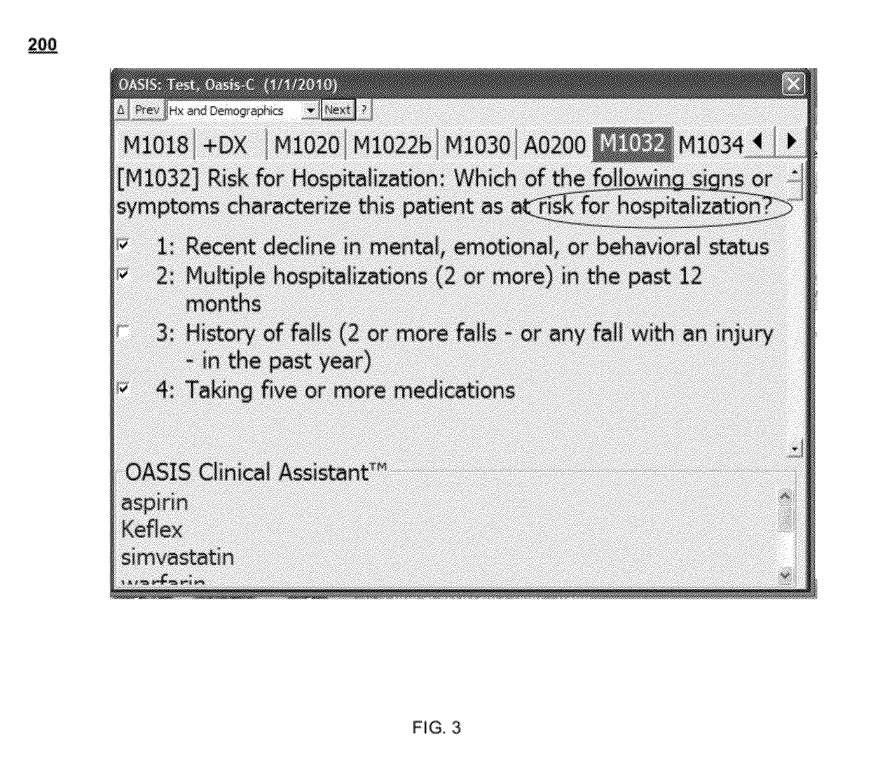

Referring also to FIGS. 3-6, various display screens rendered by form population process 10 are shown.

For example and referring also to FIG. 3, there is shown display screen 200 rendered by form population process 10 in which user 12 is answering a question concerning the “risk for hospitalization” of healthcare patient 40. One situation that is indicative of the elevated risk of hospitalization is if healthcare patient 40 is “Taking five or more medications”. In this example, form population process 10 may monitor 100 the answer being solicited from user 12, namely the “risk for hospitalization”. Form population process 10 may provide 102 user 12 with information 18 that may assist user 12 in answering the question on electronic healthcare form 16. In this particular example, form population process 10 may obtain 108 one or more pieces of corresponding information, such as a list of medications that healthcare patient 40 is currently taking, thus allowing user 12 to determine if healthcare patient is “Taking five or more medications”. This medication information may be obtained 108 from the medical chart of healthcare patient 40 or a portion of a previously-populated electronic healthcare form.

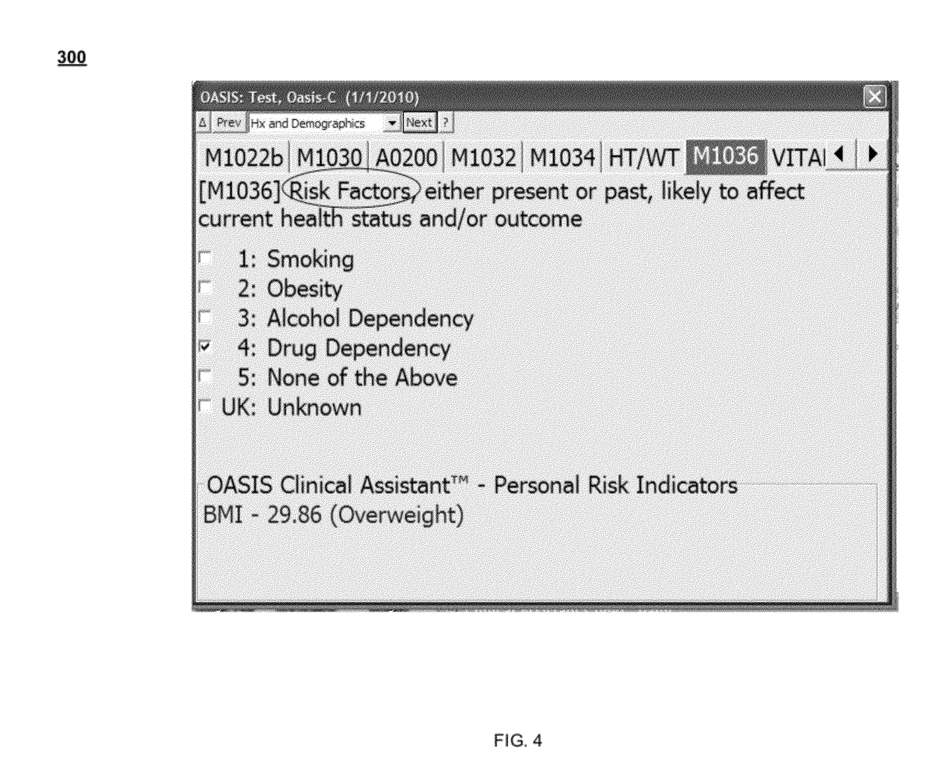

For example and referring also to FIG. 4, there is shown a display screen 300 rendered by form population process 10 in which user 12 is answering a question concerning the “risk factors” of healthcare patient 40. One such risk factor is if healthcare patient 40 is obese. In this example, form population process 10 may monitor 100 the answer being solicited from user 12, namely the “risk factors” of healthcare patient 40. Form population process 10 may provide 102 user 12 with information 18 that may assist user 12 in answering the question on electronic healthcare form 16. In this particular example, form population process 10 may obtain 108 one or more pieces of corresponding information, such as the weight of healthcare patient 40 and the height of healthcare patient 40. This information may be obtained 108 from the medical chart of healthcare patient 40 or a portion of a previously-populated electronic healthcare form. Form population process 10 may then calculate 110 information (e.g., the BMI of healthcare patient 40) based, at least in part, upon the one or more pieces of corresponding information (e.g., weight and height of healthcare patient 40), thus generating calculated information (e.g., the BMI of healthcare patient 40). Form population process 10 may then provide 112 user 12 with the calculated information (e.g., information 18, namely the BMI of healthcare patient 40) that may assist user 12 in answering the question on electronic healthcare form 16.

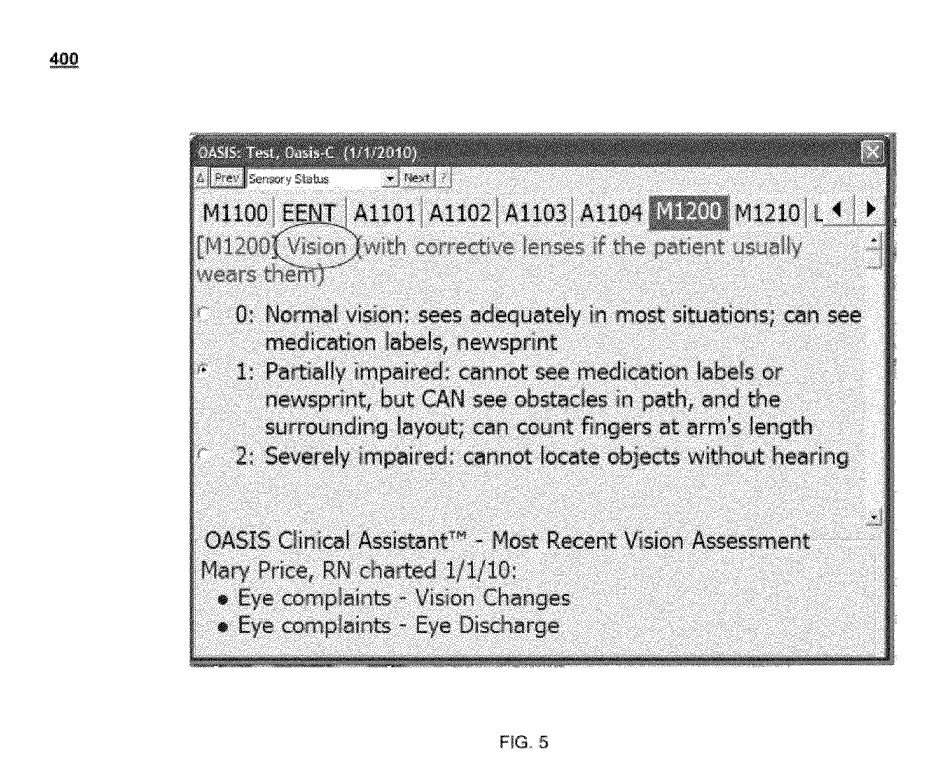

For example and referring also to FIG. 5, there is shown a display screen 400 rendered by form population process 10 in which user 12 is answering a question concerning the “vision” of healthcare patient 40. One situation that is indicative of the “vision” of healthcare patient 40 is if healthcare patient 40 is complaining about their vision. In this example, form population process 10 may monitor 100 the answer being solicited from user 12, namely the quality of the “vision” of healthcare patient 40. Form population process 10 may provide 102 user 12 with information 18 that may assist user 12 in answering the question on electronic healthcare form 16. In this particular example, form population process 10 may obtain 108 one or more pieces of corresponding information, such as a list of vision-based complaints made by healthcare patient 40, thus allowing user 12 to assign a level of impairment concerning the vision of healthcare patient 40. This list of vision-based complaints may be obtained from the medical chart of healthcare patient 40 or a portion of a previously-populated electronic healthcare form.

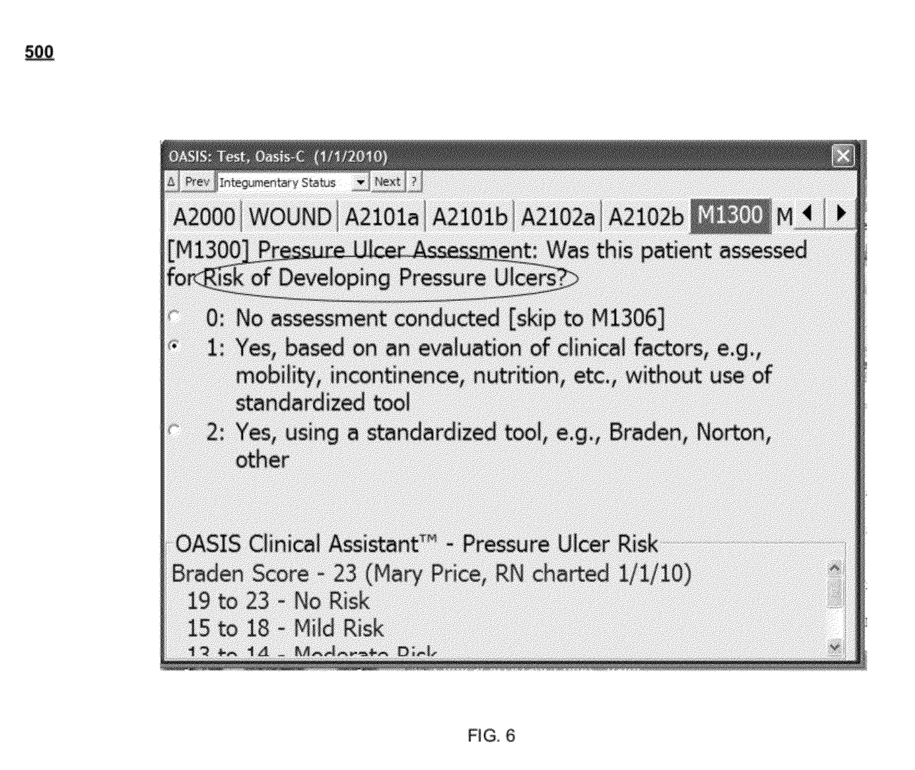

For example and referring also to FIG. 6, there is shown a display screen 500 rendered by form population process 10 in which user 12 is answering a question concerning the “risk of developing pressure ulcers” in healthcare patient 40. One situation that is indicative of the risk of developing pressure ulcers is the “Braden” score of healthcare patient 40. In this example, form population process 10 may monitor 100 the answer being solicited from user 12, namely the “risk of developing pressure ulcers”. Form population process 10 may provide 102 user 12 with information 18 that may assist user 12 in answering the question on electronic healthcare form 16. In this particular example, form population process 10 may obtain 108 one or more pieces of corresponding information, such as: the moisture of the area of concern, the sensory perception of the area, the mobility of healthcare patient 40, and the nutrition of healthcare patient 40. This medication information may be obtained 108 from the medical chart of healthcare patient 40 or a portion of a previously-populated electronic healthcare form. Form population process 10 may then calculate 110 information (e.g., the Braden Score of healthcare patient 40) based, at least in part, upon the one or more pieces of corresponding information (e.g., the moisture of the area of concern, the sensory perception of the area, the mobility of healthcare patient 40, and the nutrition of healthcare patient 40), thus generating calculated information (e.g., the Braden Score of healthcare patient 40). Form population process 10 may then provide 112 user 12 with the calculated information (e.g., information 18, namely the Braden Score of healthcare patient 40) that may assist user 12 in answering the question on electronic healthcare form 16.

Through the use of form population process 10, the likelihood of data that was previously entered incorrectly being perpetuated may be reduced. For example and for certain types of data that are easily subject to mistake, form population process 10 may be configured to require the clinician to manually enter the data each time the form is populated. For example, a transposition of a letter within a word-based answer may result in a misspelling. However, a transposition of a number within a number-based answer (e.g., a birth year or an age) may have much more serious results (e.g., birth date entered as 08-03-90 instead of 08-03-09 or an age entered as 21 instead of 12).

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

Having thus described the disclosure of the present application in detail and by reference to embodiments thereof, it will be apparent that modifications and variations are possible without departing from the scope of the disclosure defined in the appended claims.

A number of implementations have been described. Nevertheless, it will be understood that various modifications may be made. Accordingly, other implementations are within the scope of the following claims.

What is claimed is:

1. A computer-implemented, form-population method comprising:
monitoring an answer being solicited from a user of a healthcare system concerning a question included within an electronic healthcare form; and
providing the user with information that assists the user in answering the question on the electronic healthcare form.

2. The computer-implemented, form-population method of claim 1 wherein the electronic healthcare form is associated with a healthcare patient.

3. The computer-implemented, form-population method of claim 2 further comprising:
associating a portion of a medical chart associated with the healthcare patient with a portion of the electronic healthcare form.

4. The computer-implemented, form-population method of claim 1 wherein providing the user with information includes:
providing the user with one or more answers populating a previous version of the electronic healthcare form.

5. The computer-implemented, form-population method of claim 1 wherein providing the user with information includes:
obtaining one or more pieces of corresponding information.

6. The computer-implemented, form-population method of claim 5 wherein providing the user with information further includes:
calculating information based, at least in part, upon the one or more pieces of corresponding information, thus generating calculated information.

7. The computer-implemented, form-population method of claim 6 wherein providing the user with information further includes:
providing the user with the calculated information.

8. A computer program product residing on a computer readable medium having a plurality of instructions stored thereon that, when executed by a processor, cause the processor to perform operations comprising:
monitoring an answer being solicited from a user of a healthcare system concerning a question included within an electronic healthcare form; and
providing the user with information that assists the user in answering the question on the electronic healthcare form.

9. The computer program product of claim 8 wherein the electronic healthcare form is associated with a healthcare patient.

10. The computer program product of claim 9 further comprising instructions for:
associating a portion of a medical chart associated with the healthcare patient with a portion of the electronic healthcare form.

11. The computer program product of claim 8 wherein the instructions for providing the user with information include instructions for:
providing the user with one or more answers populating a previous version of the electronic healthcare form.

12. The computer program product of claim 8 wherein providing the user with information includes:
obtaining one or more pieces of corresponding information.

13. The computer program product of claim 12 wherein providing the user with information further includes:
calculating information based, at least in part, upon the one or more pieces of corresponding information, thus generating calculated information.

14. The computer program product of claim 13 wherein providing the user with information further includes:
providing the user with the calculated information.

15. A computing system comprising:
at least one processor;
at least one memory architecture coupled with the at least one processor;
a first software module executed on the at least one processor and the at least one memory architecture, wherein the first software module is configured to perform operations including monitoring an answer being solicited from a user of a healthcare system concerning a question included within an electronic healthcare form; and
a second software module executed on the at least one processor and the at least one memory architecture, wherein the second software module is configured to perform operations including providing the user with information that assists the user in answering the question on the electronic healthcare form.

16. The computer system of claim 15 wherein the electronic healthcare form is associated with a healthcare patient.

17. The computer system of claim 16 further comprising:
a third software module executed on the at least one processor and the at least one memory architecture, wherein the third software module is configured to perform operations including associating a portion of a medical chart associated with the healthcare patient with a portion of the electronic healthcare form.

18. The computer system of claim 15 wherein providing the user with information includes:
a fourth software module executed on the at least one processor and the at least one memory architecture, wherein the fourth software module is configured to perform operations including providing the user with one or more answers populating a previous version of the electronic healthcare form.

19. The computer system of claim 15 wherein providing the user with information includes:
obtaining one or more pieces of corresponding information.

20. The computer system of claim 19 wherein providing the user with information further includes:
calculating information based, at least in part, upon the one or more pieces of corresponding information, thus generating calculated information.

21. The computer system of claim 20 wherein providing the user with information further includes:
providing the user with the calculated information.
